(19) United States
(12) Patent Application Publication
(10) Pub. No.: US 2012/0232189 A1
(43) Pub. Date: Sep. 13, 2012

(54) Energetic Adhesive for Venting Cookoff

(75) Inventors: Peter J. Cahill, JR., Gainesville, VA (US); August H. Kruesi, Fairfax, VA (US); Scott K. Dawley, Culpeper, VA (US)

(73) Assignee: AEROJET-GENERAL CORPORATION, Culpeper, VA (US)

(21) Appl. No.: 13/415,155

(22) Filed: Mar. 8, 2012

Related U.S. Application Data
(60) Provisional application No. 61/450,332, filed on Mar. 8, 2011.

(51) Int. Cl. C09J 183/06; C08K 5/31; C08K 3/08; C08K 5/1545; C08K 3/22; C08K 3/18; C09J 163/00; C08K 3/04; C08K 7/18; C08K 7/20; C08K 7/10; C08K 7/06; C08K 3/28; C09J 175/04

(52) U.S. Cl. 523/435; 524/428; 524/429; 524/403; 524/195; 524/406; 524/56; 524/431; 524/590; 523/400; 523/447; 523/458; 523/461; 523/468

(57) ABSTRACT

A polymer adhesive includes a polymeric binder, optional reinforcing fibers dispersed through the polymer binder and solids dispersed in the polymeric binder. The solids are effective to cause decomposition of the polymer adhesive at a temperature between 200° F. and 500° F. with a generation of gaseous products at a predetermined temperature. One suitable composition includes siloxirane, graphite, glass beads, potassium nitrate, silver nitrate and lactose and decomposes at a temperature of about 318° F. The polymer adhesive may be used in the assembly of a housing for rocket motor or a warhead. Decomposition of the polymer adhesive when the housing is exposed to sufficient external heat to cause a rocket propellant or warhead explosive to decompose, referred to as cook-off, enables venting of the rocket propellant or warhead without uncontrolled destructive rupture of the housing.

### CROSS REFERENCE TO RELATED APPLICATION(S)

This patent application claims priority to U.S. Provisional. Patent Application Ser. No. 61/450,332, titled “Energetic Adhesive for Venting Cookoff,” that was filed on Mar. 8, 2011. The disclosure of U.S. 61/450,332 is incorporated by reference herein in its entirety.

### U.S. GOVERNMENT RIGHTS

N.A.

### BACKGROUND

1. Field of the Disclosure

This disclosure relates to structures effective to vent decomposition products of rocket motors and warheads exposed to external heat. More particularly, a component of the rocket motor or warhead is adhesively joined to the structure with an energetic adhesive that decomposes with a generation of gas at a predetermined temperature.

2. Description of the Related Art

A majority of intermediate- to large-diameter solid rocket motors and warheads exhibit a violent response to a thermal threat, such as exposure to a fuel fire (referred to as “fast cook-off”) or an adjacent storage fire (referred to as “slow cook-off”). Venting of the rocket motor or warhead is an important step to reduce cook-off violence.

Many auto-igniting materials and devices have been developed in the defense and commercial industries that exhibit a broad range in auto-ignition temperatures. Pyrotechnic devices tend to provide the least expensive method for producing an auto-ignition in a temperature range for a given heating rate, but the ignition temperature can vary dramatically for different heating rates and material thickness. In contrast, intermetallic composite materials made from an active metal and an electronegative metal or alloy exhibit much less variability in auto-ignition temperature regardless of heating rate, but sensors constructed of such materials tend to be considerably more expensive than their pyrotechnic counterparts.

While it is understood that there are safety considerations that must be addressed when including any temperature-sensitive materials into a rocket motor, there is historical credence to the possibility of including these devices when either a) their inadvertent activation can be completely prevented or b) inadvertent actuation is a sufficiently low-probability event which results in a benign response that disables the normal ignition system and can be easily detected, preventing future safety concerns. Some missile systems currently utilize a Thermally Initiated Venting Device (TIVS), which includes a high-temperature pyrotechnic device to initiate a firing train for a cutting charge that opens the motor case in the event of fast cook-off (FCO). Such a system is disclosed in U.S. Pat. No. 4,597,261, titled “Thermally Actuated Rocket Motor Safety System.” These systems are being expanded to address the problem of slow cook-off (SCO) by utilizing an inter-metallic initiation device. Other missile systems currently utilize a pyrotechnic device to initiate a similar firing train to mitigate both FCO and SCO, where the pyrotechnic material has been designed to ignite at an appropriate response temperature in both events with respect to the system response temperature. U.S. Pat. No. 7,530,314, titled “Thermally Initiated Venting System and Method of Using Same” discloses a system expanded to address both FCO and SCO.

Autoignition propellants are an early-initiating safety device for defense and commercial applications. These devices reliably initiate a small, localized reaction which vents a main propellant when exposed to a fire. Acceptable autoignition propellants must demonstrate stability at extreme temperatures for extended durations without negative effects. U.S. Pat. No. 6,143,101, titled “Chlorate-Free Autoignition Compositions and Methods,” defines an autoignition propellant as a composition that will autoignite and initiate the combustion of a main gas generating pyrotechnic charge at a temperature below that at which a shell or housing begins to soften and lose structural integrity. One composition disclosed in U.S. Pat. No. 6,143,101 is, by weight, 69.46% azodiformamidine dinitrate, 13.85% ammonium perchlorate, 10.03% sodium nitrate, 4,76% iron oxide and 1.90% polypropylene carbonate binder. The composition is disclosed as having an autoignition temperature of 160° C.±5° C. (320° F.±9° F.).

U.S. Pat. No. 6,749,702, titled “Low Temperature Autoignition Composition,” discloses an autoignition composition containing, by weight, 39.4% silver nitrate, 23.5% potassium nitrate and 37.1% molybdenum. The composition is disclosed as having an autoignition temperature between 130° C. and 135° C. (266° F. and 275° F.).

Most commercial autoignition formulations are designed to initiate at 290° F.-300° F., depending on size, when exposed to 6° F. per hour heating rate. High-performance rocket motors react violently just above this temperature in slow cook-off, and tests have shown that many propellants are beyond the point-of-no-return (PNR) when they reach this temperature in an SCO scenario. That is to say that even if the fire were extinguished, self-heating reactions will lead to violent cook-off of the rocket motor if unmitigated.

U.S. Pat. No. 7,762,195, titled “Slow Cook Off Rocket Igniter,” discloses a rocket motor containing an autoignition propellant and a variable diameter port. The port has a relatively large diameter when the motor is in a “safe” condition such that if the autoignition propellant ignites the main propellant, gaseous products are expelled through the port at a pressure below which the housing may rupture. The port diameter is reduced when the motor is in an “armed” position.

U.S. Pat. Nos. 6,143,101; 6,749,702; and 7,762,195 are incorporated by reference herein in their entireties.

### BRIEF SUMMARY OF THE INVENTION

It is an object of embodiments described herein to facilitate instantaneous venting of a rocket motor or a warhead when the external temperature exceeds a tailorable design temperature.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

FIG. 1 illustrates in cross-sectional representation a rocket motor having a closure sealed with the energetic adhesive disclosed herein.

FIG. 2 is a magnified view of a joint for the rocket motor of FIG. 1.

FIG. 3 illustrates in cross-sectional representation a warhead having a closure sealed with the energetic adhesive disclosed herein.

FIG. 4 illustrates in cross-sectional representation a scarf joint effective to tailor the failure pressure of a closure.

FIG. 5 graphically illustrates the effect of ammonium perchlorate particle size on autoignition temperature.

FIG. 6 graphically illustrates thermal degradation of autoignition temperature as a function of time and temperature.

Like reference numbers and designations in the various drawings indicate like elements.

### DETAILED DESCRIPTION

Throughout this application, all compositions are in weight percent, unless otherwise specified. All test data is at room temperature, nominally 22° C., unless otherwise specified.

The energetic adhesive disclosed herein is applied and allowed to cure at the final assembly level of a rocket motor or warhead, when the closures are installed, where absent the use of the energetic adhesive the resulting confinement could lead to unsatisfactory responses to thermal threats. When the assembled unit is exposed to extreme temperature, the energetic adhesive decomposes resulting in an instantaneous, complete failure of the bond and elimination of the confinement prior to ignition of the rocket propellant or explosive. Gas generated by decomposition of the energetic adhesive forces expulsion of the bonded closures from the pressure vessel.

The energetic adhesive is a polymer-based energetic composition that can be used to bond surfaces together. The composition has an autoignition temperature of between 200° F. and 500° F. More preferably, the autoignition temperature is between 240° F. and 350° F. Most preferably, the autoignition temperature is from 275° F. and 320° F. The autoignition temperature can be tailored based on a desired application. When the bonded joint is exposed to extreme temperatures, the adhesive decomposes resulting in an instantaneous, complete failure of the bond. This technology is applied to bonded closures for solid rocket motors where the ignition causes sufficient gas generation to expel the closures prior to ignition of the main rocket propellant or explosive. This technology is also applied to warheads where ignition causes sufficient gas generation to expel a fuze system or components prior to ignition of the explosive fill. This technology can be used to meet insensitive munitions requirements for exposure to fuel fires (fast cook-off) and adjacent storage fires (slow cook-off).

The energetic adhesive includes a fiber reinforced polymer resin binder and solids dispersed through the binder. The resin binder makes up between 25% and 75% of the energetic adhesive composition and has a structural capability that exceeds 1500 psi of stress, and preferably exceeds 2000 psi of stress. More preferably, the resin binder makes up between 35% and 50% of the composition. The reinforcing fiber is up to 1% of the energetic adhesive composition and preferably forms from 0.4% to 0.7% of the composition. Suitable polymers for the resin binder include epoxies, polyurethanes and siloxirane, with siloxirane being preferred. Siloxirane is a high functionality, two component thermoset polymer coating manufactured by Advanced Polymer Coatings of Avon, Ohio.

One exemplary reinforcing fiber is graphite fiber having a nominal length of 200 microns and nominal diameter of 20 microns. Another suitable graphite fiber has a nominal length of 3000 microns and a nominal diameter of 5 microns. Another suitable reinforcing fiber is silica fiber with similar diameters and lengths as the graphite fiber. The use of silica fiber provides a higher temperature ignition and a lower burn rate than graphite fiber. Graphite fiber is therefore preferred.

Alternatively, reinforcement can be accomplished with Sil-co-sil which is ground silica (silicone dioxide, SiO₂) manufactured by U.S. Silica of Berkeley Springs, W. Va. or traditional glass beads. The advantage of using near spherically ground material or glass beads is that the reinforcing material also functions to control the adhesive application and bond thickness. For this purpose glass beads are preferred. These glass beads vary in size from 250 micron diameter to 750 micron diameter depending on the desired bond thickness. The preferred glass beads are 500 +/−50 micron diameter. It is preferred to utilize both graphite fiber and glass beads in combination.

Solids are dispersed uniformly through the resin binder. The solids are a mixture of solid oxidizers, solid fuels and catalysts. Suitable oxidizers include ammonium perchlorate, ammonium nitrate, silver nitrate, guanidine nitrate, potassium nitrate and potassium chlorate. Suitable fuels include sucrose, lactose, tungsten, molybdenum, and carbon. Suitable catalysts include copper chromite and iron oxide. All solids are about the same size, approximately 3-5 micron along their longest axis. Typically, this longest axis length/diameter will be between 1 micron and 45 micron. All materials will pass through a 325 mesh screen.

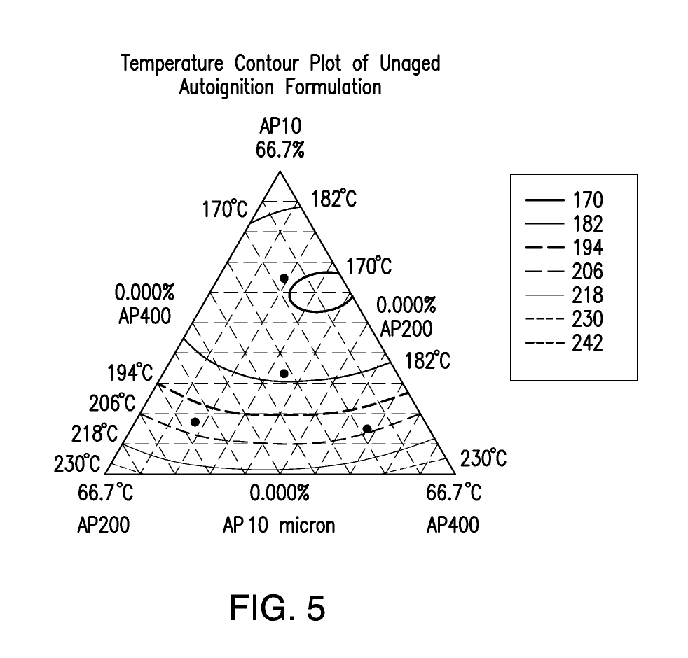

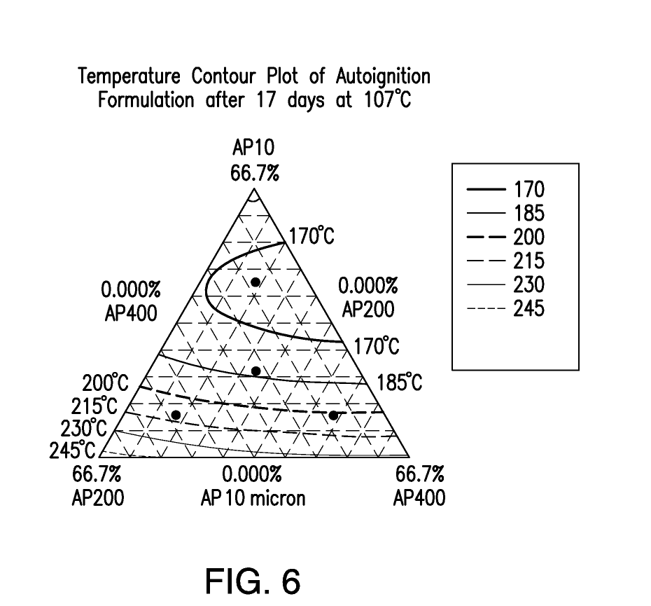

The solid oxidizers (ammonium perchlorate, ammonium nitrate, silver nitrate, guanidine nitrate, potassium nitrate and/or potassium chlorate) are materials used to provide an onboard source of oxygen in the epoxy matrix and control the auto-ignition temperature of the mixture. The oxidizer can be made up of a mixture of nitrates (ammonium nitrate, guanidine nitrate, potassium nitrate, and silver nitrate), but should not include a mixture of ammonium perchlorate with guanidine nitrate, potassium nitrate, or silver nitrate because of incompatibility. It is possible to use a mixture of ammonium nitrate and ammonium perchlorate if no other oxidizer is used. Potassium chlorate, if used must comprise all of the oxidizer in the mixture. The total amount of oxidizer added is from 40%-70%. The particle size of the oxidizer is used to manipulate the autoignition temperature of the adhesive, with ammonium perchlorate being preferred. In the preferred version of the adhesive, the amount of ammonium perchlorate added is from 40% to 70% with no other oxidizer. More preferably, the ammonium perchlorate content is between 50% and 60%. FIG. 5 demonstrates the effect of ammonium perchlorate (AP) particle size on the ignition temperature. Note that auto-ignition temperatures in the range of 300° F. were obtained through simply increasing the proportion of fine AP. The AP particle size is preferably from 500 nanometers to 45 microns and most preferably 2 microns±2 micron. FIG. 6 shows that the autoignition temperature remains relatively unchanged after exposure to 225° F. for 17 days. This long-term stability at high-temperature makes these materials suitable for use in highly-energetic systems which may experience storage at temperatures up to 180° F. for periods as long as 500 days. An alternate version of the adhesive uses a combination of silver nitrate and potassium nitrate as the oxidizer. The silver nitrate content is between 5% and 25% and the potassium nitrate composition is between 20% and 40%.

Copper chromite and/or iron oxide are added to catalyze the reaction. The total amount of copper chromite and iron oxide added is from 0% to 10%. More preferably, the copper chromite content is between 0% and 5% and the amount of iron oxide is between 0% and 5%.

Molybdenum, tungsten, lactose, carbon powder and sugar are added to provide readily available fuel to initiate the reaction with the oxidizer. Because the binder system is also a fuel, the total amount of fuel additives is low, typically 0% to 30%. More preferably, the total fuel content is between 0% and 15%. These materials can be used alone or mixed together to provide the total fuel content. The preferred embodiment of the invention contains between 5% and 10% lactose.

Table 1 summarizes the energetic adhesive compositions:

TABLE 1

| | | Composition Range (By Weight) | | | |
|---|---|---|---|---|---|
| Composition | | Function | Broad | Preferred | Exemplary |
| Binder | Siloxirane | Binder/ | 25%-75% | 35%-50% | 39.5% |
| | | Adhesive | | | |
| | Epoxy | Binder/ | | | |
| | | Adhesive | | | |
| | Polyurethane | Binder/ | | | |
| | | Adhesive | | | |
| Reinforcing | Graphite | Reinforcing | Up to 1% | 0.4%-0.7% | 0.5% |
| Material | Silica Fiber | Fiber | | | |
| | Sil-co-sil | Reinforce | | | |
| | Glass beads | and Control Bond | | | |
| | | Thickness | | | |
| Solids | Ammonium | Solid | 40%-70% | 50%-60% | 55.0% |
| | Perchlorate | Oxidizer | | | |
| | Ammonium | | | | |
| | nitrate | | | | |
| | Silver Nitrate | | | | |
| | Guanidine | | | | |
| | Nitrate | | | | |
| | Potassium | | | | |
| | Nitrate | | | | |
| | Potassium | | | | |
| | Chlorate | | | | |
| | Molybdenum | Solid Fuel | 0-30% | 0-15% | 0% |
| | Sucrose | | | | |
| | Lactose | | | | |
| | Tungsten | | | | |
| | Molybdenum | | | | |
| | Carbon | | | | |
| | Copper | Catalyst | 0-10% | 0-5% | 5.0% |
| | Chromite | | | | |
| | Iron Oxide | | | | |

Thermal Analysis has shown that, when bonded beneath the normal rocket motor sidewall insulation, the above formulation has thermal margins of safety which exceed rocket motor design margins. This formulation meets the first safety criteria that initiation will not occur unless the main propellant formulation is under imminent threat of cook-off.

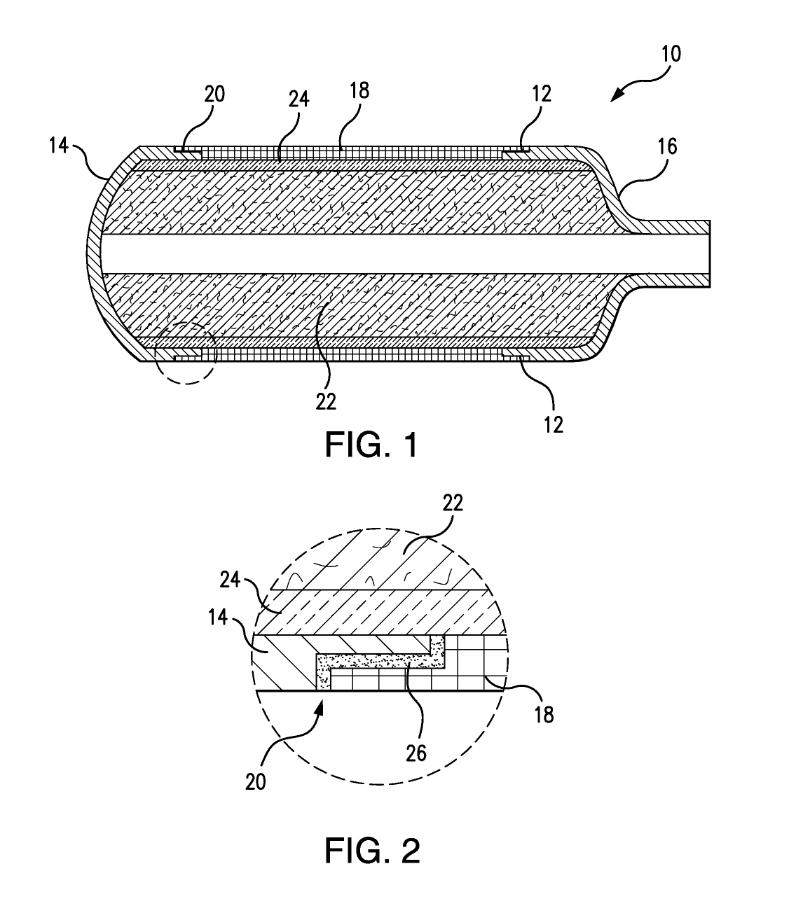

FIG. 1 illustrates in cross-sectional representation a rocket motor 10 having a joint 12 sealed with the energetic adhesive described above. The rocket motor 10 includes a forward closure 14 and an aft closure 16 both of which are typically formed from a metal such as aluminum. The sidewall 18 of the rocket motor 10 is typically formed from a wound composite tube. The sidewall 18 is adhesively bonded to the aft closure 16 at the joint 12 and to forward closure at the joint 20. Both the length and the shape of the joints 12, 20 may be shaped to achieve a desired minimum yield stress for non-decomposed adhesive as described below. The rocket motor 10 is filled with a suitable rocket propellant 22. An insulation layer 24 isolates the energetic adhesive at joints 12, 20 from the rocket propellant 22 so that the heat of burning rocket propellant does not cause the energetic adhesive to decompose.

FIG. 2 is a magnified view of a joint 20 for the rocket motor of FIG. 1. The joint 20 is at the interface between sidewall 18 and forward closure 14. Energetic adhesive 26 fills the joint 20 to bond the adjoining sidewall 18 and forward closure 14. Insulation layer 24 thermally isolates the energetic adhesive 26 from the rocket propellant 22 such that the energetic adhesive is primarily exposed to heat from outside the rocket motor as would be present during a slow cook-off or fast cook-off event.

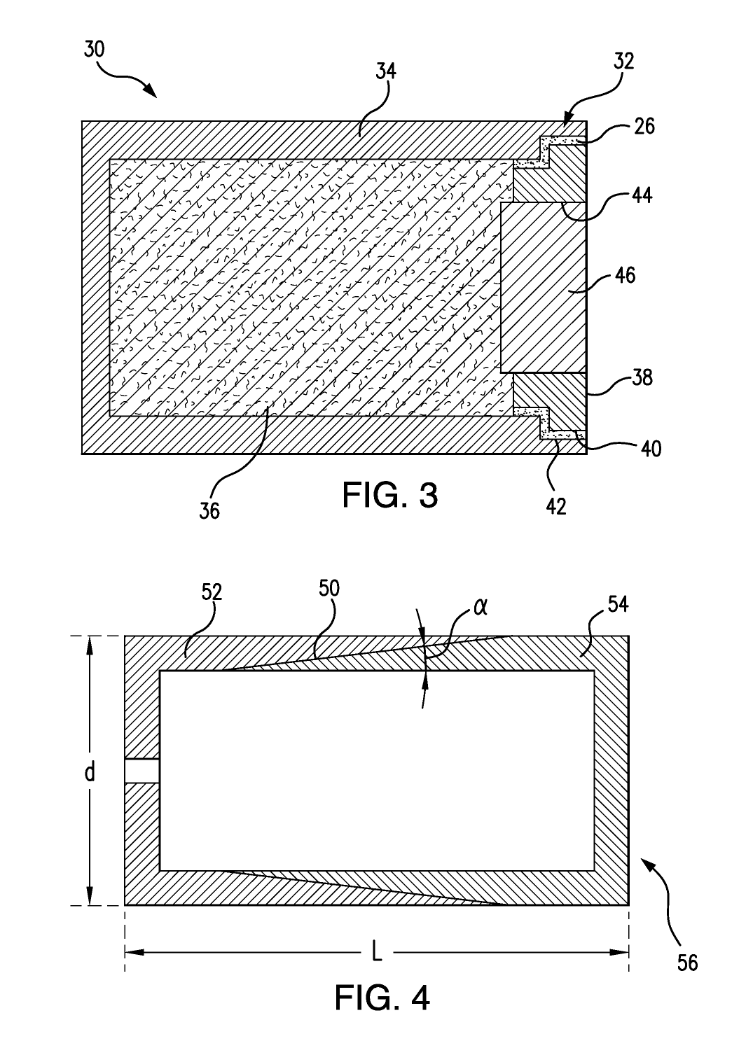

FIG. 3 illustrates in cross-sectional representation a warhead 30 having a joint 32 sealed with the energetic adhesive 26 described above. The warhead 30 includes a casing 34 formed from a metal such as steel that is filled with a suitable explosive 36. A ring 38, typically formed from steel, has an exterior surface 40 shaped to cooperate with an interior surface 42 of the aft end of warhead 30 to form joint 32. An inner bore 44 of the ring 38 is shaped to receive a fuze 46. For example, the inner bore may be threaded to receive a current in-service fuze adapter.

FIG. 4 illustrates in cross-sectional representation a scarf joint 50 that is one way to effectively tailor the failure pressure. The scarf joint contains the energetic adhesive and is effective to join first housing portion 52 to second housing portion 54. Both the length of the scarf joint and the angle, a, may be tailored to achieve a desired failure pressure.

Referring back to FIG. 1, when the rocket motor 10 is exposed to external heat and a cook-off event, either slow or fast, is initiated, the energetic adhesive decomposes and generates gas from reaction of the solid oxidizer with the solid fuel and binder components of the energetic adhesive. The decomposition temperature is accurately controlled by oxidizer selection (including particle size) and the amount of catalyst included. Decomposition weakens the joint 12, strength and the gas generates a pressure effective to expel the closure from the sidewall 18 of the rocket motor thereby providing ample area to safely vent decomposition products of the rocket propellant 22.

Referring back to FIG. 3, when the warhead 30 is exposed to external heat and a cook-off event, either slow or fast, the energetic adhesive 26 decomposes weakening the joint 32. The gas generated creates an outward force expelling the ring 38 and fuze 46 providing an opening ample to safely vent decomposition products of the explosive 36 and safely remove the fuze 46 from the explosive to prevent inadvertent detonation.

Advantages of the embodiments described above will be further understood from the Examples that follow:

### EXAMPLES

### Example 1

An energetic adhesive having the composition detailed in Table 2 was compounded and its properties evaluated. The formulation was insensitive and robust and exhibited excellent thermal properties for a formulation with 50% solids loading. The composition did not include a catalyst or graphite, both of which will further decrease the autoignition temperature.

TABLE 2

| Designation | Energetic Adhesive |
|---|---|
| Formulation | 50% Siloxirane Resin |
| (weight percent) | 33% Potassium Nitrate |
| | 8.3% Silver Nitrate |
| | 8.3% lactose |
| Copper Block Rapid Rise to Autoignition | 318° F. |

### Example 2

With reference to FIG. 4, an aluminum test fixture having a diameter of 2.16 inches was formed with a scarf joint 50 having a length, L, of 4.88 inches. A conventional epoxy adhesive impregnated with glass microbeads achieved a joint with a burst pressure in excess of 14,000 psi. Failure occurred at the aluminum end plate 56 and not at the bond. Increasing the length of the bond, by decreasing a should achieve failure pressures in line with design rupture pressures for larger diameter motors.

One or more embodiments of the present invention have been described. Nevertheless, it will be understood that various modifications may be made without departing from the spirit and scope of the invention. For example, this adhesive could be used in other munitions packaging features where threaded joints or inert adhesive bonds are currently used. Accordingly, other embodiments are within the scope of the following claims.

What is claimed is:

1. A polymer adhesive, comprising:
a polymeric binder;
optional reinforcing fibers, spherical materials and mixtures thereof dispersed through said polymer binder: and
solids dispersed in said polymeric binder wherein said solids are effective to cause decomposition of said polymer adhesive with a generation of gaseous products at a predetermined temperature.

2. The polymer adhesive of claim 1 wherein:
said polymeric binder is selected from the group consisting of epoxies, polyurethanes, siloxirane and mixtures thereof;
said reinforcing fibers are selected from the group consisting of graphite, sil-co-sil and mixtures thereof, said spherical materials are selected from the group consisting of silica, glass beads and mixtures thereof; and
said solids are selected from the group consisting of ammonium perchlorate, ammonium nitrate, silver nitrate, guanidine nitrate, potassium nitrate, potassium chlorate, molybdenum, carbon powder, tungsten, lactose, sucrose, copper chromite, iron oxide and mixtures thereof.

3. The polymer adhesive of claim 2 wherein said predetermined temperature is between 240° F. and 350° F.

4. The polymer adhesive of claim 2 consisting essentially of, by weight:
from 25% to 75% of said polymeric binder;
up to 1% of said reinforcing fibers and spherical materials: and
the balance said solids.

5. The polymeric adhesive of claim 4 wherein said polymeric binder is siloxirane, said reinforcing fibers are graphite, said spherical materials are glass beads and said solids are a mixture of ammonium perchlorate and copper chromite.

6. The polymeric adhesive of claim 4 wherein said polymeric binder is siloxirane, said reinforcing fibers are graphite, said spherical materials are glass beads and said solids are a mixture of potassium nitrate, silver nitrate and lactose.
